(19) United States
(12) Patent Application Publication
(10) Pub. No.: US 2009/0021041 A1
(43) Pub. Date: Jan. 22, 2009

(54) OPERATING UNIT FOR AT LEAST ONE ADJUSTER OF A VEHICLE SEAT

(76) Inventor: Michael Ritzel, Kirchheim/Teck (DE)

Correspondence Address: MCGLEW & TUTTLE, PC, P.O. BOX 9227, SCARBOROUGH STATION, SCARBOROUGH, NY, 10510-9227, US

(21) Appl. No.: 12/278,625

(22) PCT Filed: Sep. 9, 2007
(86) PCT No.: PCT/EP2007/007652

§ 371 Date: Aug. 7, 2008

(30) Foreign Application Priority Data
Sep. 9, 2006 (DE) 10 2006 042 450.6

(51) Int. Cl. B60N 2/02; H01H 15/00; H01H 25/00

(52) U.S. Cl. 296/65.18; 200/5 R; 200/16 R

(57) ABSTRACT

In the case of an operating unit (1) for at least one adjuster of a vehicle seat (3), in particular a motor vehicle seat, with a housing (5) and an operating element (11), with the movement and/or operation of which the at least temporarily assigned adjuster is activated, the adjuster adjusting the vehicle seat (3) or a component (7) of the same, the operating element (11) is movable along a slotted guide (9) which is provided in the housing (5) and at least approximately simulates the profile of the vehicle seat (3).

### CROSS REFERENCE TO RELATED APPLICATIONS

This application is a United States National Phase application of International Application PCT/EP2007/007652 and claims the benefit of priority under 35 U.S.C. § 119 of German patent application DE 10 2006 042 450.6 filed Sep. 9, 2006, the entire contents of which are incorporated herein by reference.

### FIELD OF THE INVENTION

The present invention pertains to an operating unit for at least one adjuster of a vehicle seat, in particular a motor vehicle seat.

### BACKGROUND OF THE INVENTION

In the case of a known operating unit, two operating elements are accessible at the side of the vehicle seat. One of them has two different movement possibilities. By pushing it forward and back, the longitudinal adjuster is activated in order to change the longitudinal position of the seat, while upon pushing it up and down, the height adjuster changes the seat height. When the second adjustment element is pivoted, the backrest pivots forward and back. The functions can also be integrated in a single, multifunctional operating element, as described in EP 0 796 766 A2, the operating element providing four operating possibilities. However, these solutions come up against limiting factors if further adjusters and functions are to be integrated.

An operating unit of the type mentioned at the beginning is therefore proposed in EP 1 178 897 B1. An array of switches simulating the profile of the vehicle seat is used to select an adjuster or an adjustable component of the vehicle seat, which is then activated to the desired extent by means of a separate, multifunctional operating element.

### SUMMARY OF THE INVENTION

The invention is based on the object of improving an operating unit of the type mentioned at the beginning. The subject is achieved according to the invention by an operating unit with a housing defining a slotted guide. An operating element is mounted for movement such that movement and/or operation of the operating element activates the at least one adjuster. The adjuster adjusts the vehicle seat or a component of the vehicle seat. The operating element is moveable along an operating element path defined by the slotted guide. The operating element path has a contour that corresponds to a profile of the vehicle seat.

The slotted guide may have individual discrete operating points. One of the operating points may receive the operating element such that the operating element activates the at least one adjuster when the operating element is located at one of the operating points. The slotted guide may have connecting sections. One connecting section may connect one of the operating points with another of the operating points. The operating element may not activate the at least one adjuster when the operating element is located in one of the connecting sections.

Each operating point may correspond to one or more adjusters of the vehicle seat or each operating point may correspond to a different operating function for adjusting the one or more adjusters of the vehicle seat.

A position of one of the operating points within the slotted guide may correspond to an assigned adjuster. The assigned adjuster may move one or more of a backrest component of the vehicle seat, a bottom portion of the vehicle seat and another portion of the vehicle seat when the operating point is located within one of the operating points.

The operating element may receive a force such that the operating element moves in an oblique direction or pivots or rotates about an axis thereof when the operating element is located at one of the operating points.

The operating element may perform at least some operating functions assigned to the operating points.

The operating element may be moveable from one operating point to another operating point via one of the connecting sections.

The operating element may not be assigned to a new adjuster when the operating element is located in one of the connecting sections.

The operating element may be located in a bearing in the housing when the operating element is located at one of the operating points. The operating element may be latched into the bearing when the operating element is located at one of the operating points.

The operating element may be lifted or pressed out of the bearing along a longitudinal axis of the operating element when the operating element moves from one of the operating points to one of the connecting sections.

The operating unit may comprise a sensor that detects a position of the operating element within the slotted guide.

The sensor may register the operations of the multifunctional operating element.

The sensor may be a three-dimensional Hall sensor.

Owing to the fact that the operating element is moveable along a slotted guide which is provided in the housing and at least approximately simulates the profile of the vehicle seat, the occupant can intuitively recognize which adjusters are activated by the operating element. Individual, discrete operating points are preferably unambiguously assigned certain adjusters. At the operating points, the operating element can preferably be operated in a multifunctional manner while the multifunctionality is suspended in connecting sections in between. A sensor preferably at least interrogates the position of the operating element. A corresponding controller determines which adjuster is to be activated and to what extent.

In particular if there are a plurality of activatable adjusters, a substantially smaller construction space is taken up than in the event of an operating element being provided for each adjuster. In addition, the operating unit remains clear and therefore easily operable. The invention is suitable in particular for vehicle seats with numerous additional adjustments and additional functions, for example the adjustment of side cheeks, lumbar supports or thigh supports, in addition to the main adjustment possibilities, such as longitudinal position of the seat, seat height and backrest inclination. An occupant-related storage of the adjustments and functions is possible.

The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which a preferred embodiment of the invention is illustrated.

### BRIEF DESCRIPTION OF THE DRAWINGS

In the drawings:

FIG. 1A is a side view of the exemplary embodiment, with the operating element being located at an operating point;

FIG. 1B is a side view of the assignment of the operating possibilities of the operating element to the activation possibilities of the adjusters assigned to the operating point of FIG. 1A;

FIG. 2A is a side view of the exemplary embodiment, with the operating element being located at a further operating point;

FIG. 2B is a side view of the assignment of the operating possibilities of the operating element to the activation possibilities of the adjusters assigned to the operating point of FIG. 2A

FIG. 3A is a side view of the exemplary embodiment, with the operating element being located at a third operating point;

FIG. 3B is a side view of the assignment of the operating possibilities of the operating element to the activation possibilities of the adjusters assigned to the operating point of FIG. 3A;

FIG. 4A is a side view of the exemplary embodiment, with the operating element being located at a fourth operating point;

FIG. 4B is a side view of the assignment of the operating possibilities of the operating element to the activation possibilities of the adjusters assigned to the operating point of FIG. 4A; and

FIG. 5 is a perspective view of a vehicle seat.

### DESCRIPTION OF THE PREFERRED EMBODIMENTS

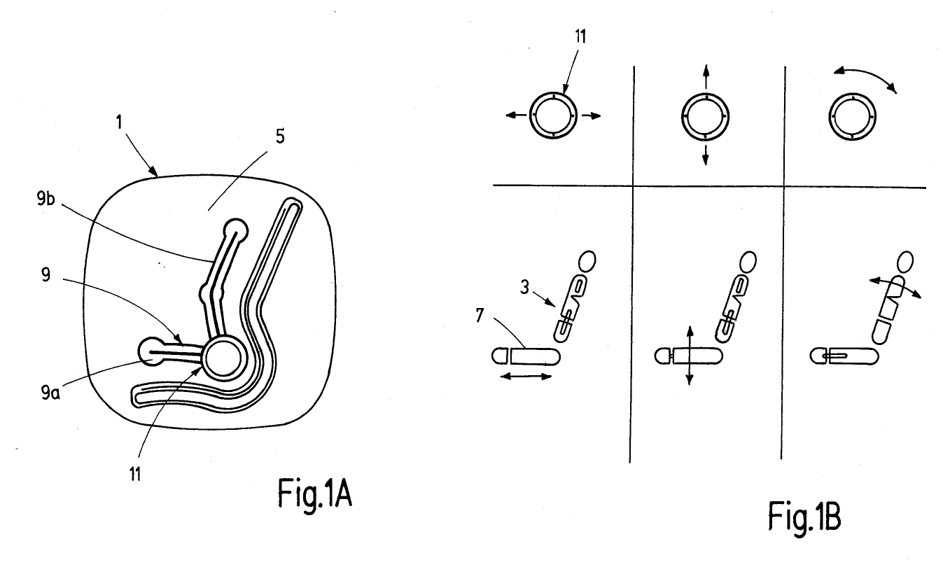

Referring to the drawings in particular FIG. 1A and FIG. 1B, an operating unit 1 is provided for the selective activation of a plurality of adjusters of a vehicle seat 3 in a motor vehicle. The operating unit 1 comprises a housing 5 which is largely recessed within a component 7 of the vehicle seat 3, for example a seat-part side cheek, but could also be arranged at a different point of the vehicle seat 3 or of the surroundings thereof. A slotted guide 9 is formed on that side of the housing 5 which is visible to the occupant of the vehicle seat 3, the slotted guide at least approximately, i.e. schematically, simulating the profile of the vehicle seat 3, i.e. approximately having the shape of an “L”. In this case, the slotted guide 9 has individual, discrete regions with a somewhat larger width, referred to below as operating points 9a, and, in between, elongated regions with a somewhat smaller width, referred to below as connecting sections 9b which connect the operating points 9a to one another. In the present case, four circular operating points 9a and three connecting sections 9b are provided.

An operating element 11 which projects by means of its gripping region outward through the slotted guide 9 and is normally located at one of the operating points 9a is mounted within the housing 5. The operating element 11 can be operated in a multifunctional manner by being able to be acted upon both obliquely and subsequently pivotably and also, because of a torque, being rotatable about its axis, to be precise in two directions in each case. In the image of the vehicle seat 1 in which it is simulated by the slotted guide 9, the operating element 11 can be pivoted to the left and right and up and down and can be rotated in the clockwise direction and counterclockwise. The operating element 11 is preferably designed in a manner corresponding to a joystick.

The operating element 11 has this multifunctionality at the operating points 9a only when it is located in a bearing, which is assigned to the operating point 9a, in the housing 5, preferably is latched into it. Pulling, for example counter to a spring, enables the operating element 11 to be lifted out of the bearing and, if required, to be moved via the adjacent connecting section 9b to the adjacent operating point 9a. During the movement in the connecting section 9b, the multifunctionality is blocked or suspended in some other manner, and the operating element 11 is only moveable along the connecting section 9b. As soon as the adjacent operating point 9a is reached, the operating element 11 can drop, preferably latched, into the bearing there. When the operating element 11 is seated in the new bearing, its multifunctionality can be fully deployed again.

Each operating point 9a is assigned at least one particular adjuster of the existing adjusters of the vehicle seat 3, i.e. the motorized adjustment devices for the vehicle seat 3, or individual components 7, or a different function. The position of the operating point 9a within the slotted guide 9 indicates the assigned adjuster, the component 7 moved by the latter or the adjustment possibility of the vehicle seat 3, or the different function. Additional displays are possible. In the exemplary embodiment, the assignment indicated below is selected.

The operating point 9a at the bending point of the slotted guide 9 (FIG. 1A) is assigned to the seat longitudinal adjuster, the seat height adjuster and the backrest inclination adjuster, i.e. pivoting the operating element 11 to the left or right moves the vehicle seat 3 forward or back, pivoting it up or down raises the vehicle seat 3 or lowers it, and rotating it in clockwise direction or counterclockwise pivots the backrest to the rear or forward.

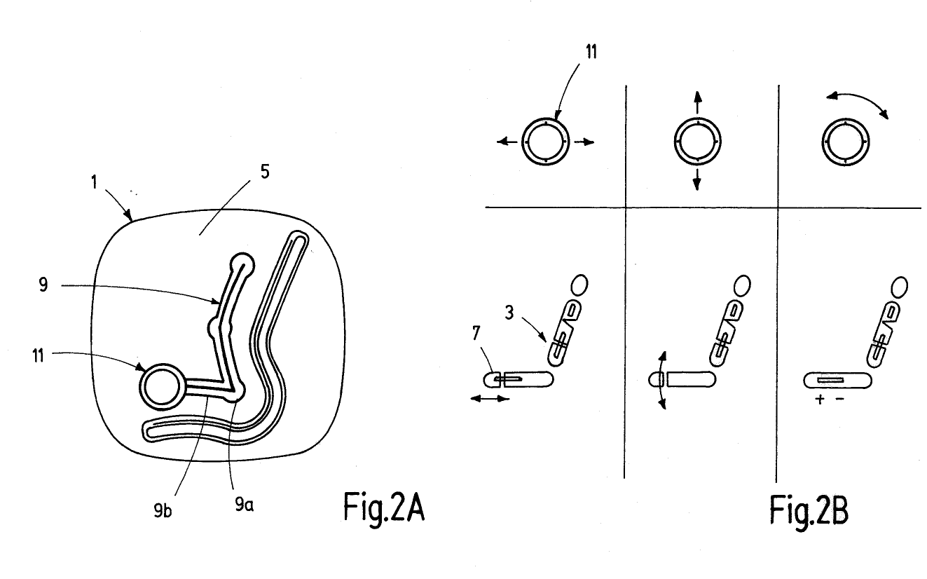

The operating point 9a upstream of the bending point of the slotted guide 9 (FIG. 2A) is assigned to the seat surface extension, the seat inclination adjuster and the seat-part side-cheek adjuster, i.e. pivoting the operating element 11 to the left and right extends and shortens the seat surface, pivoting it up and down adjusts the vehicle seat 3 to be more upright and flatter, and rotating it in the clockwise direction and counterclockwise pivots the seat-part side cheeks inward and outward.

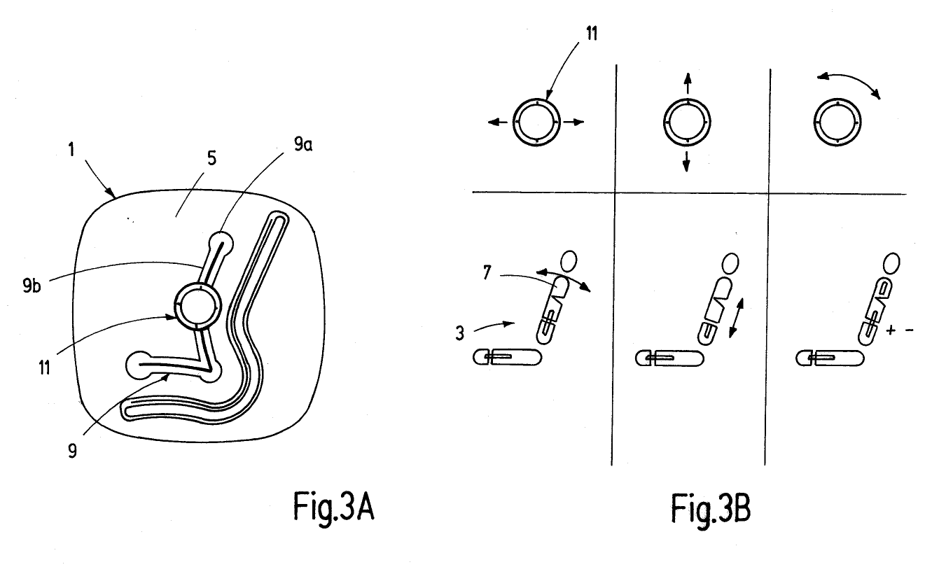

The operating point 9a above the bending point of the slotted guide 9 (FIG. 3A) is assigned to the shoulder inclination adjuster, the backrest height adjuster and the seat-part side-cheek adjuster, i.e. pivoting the operating element 11 to the left and right pivots the upper part of the backrest forward and back, pivoting it up and down moves the upper part of the backrest up and down, and rotating it in the clockwise direction and counterclockwise pivots the seat-part side cheeks inward and outward.

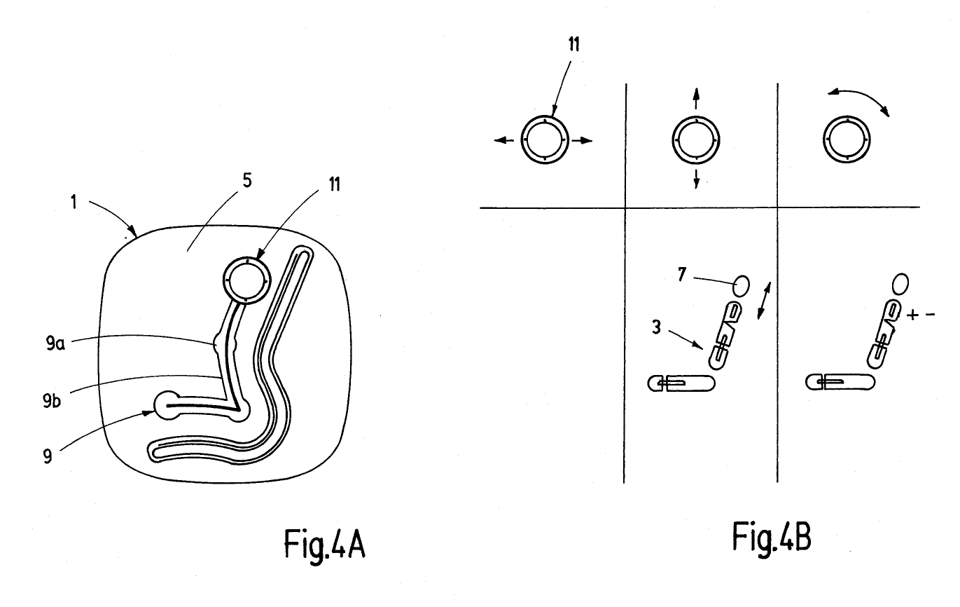

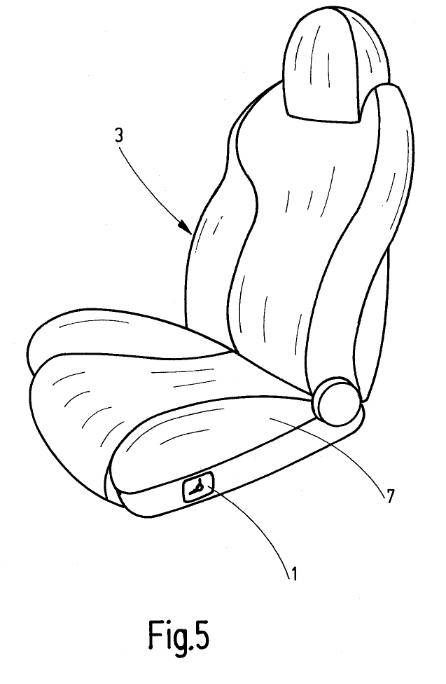

The operating point 9a above the last-mentioned operating point 9a (FIG. 4A) is assigned to the head restraint height adjuster and the shoulder side-cheek adjuster, i.e. pivoting the operating element 11 up and down moves the head restraint up and down, and rotating it in the clockwise direction and counterclockwise pivots the shoulder side cheeks inward and outward.

In order to detect at which position in the slotted guide 9, in particular at which operating point 9a the operating element 11 is located, a sensor is provided, in the present case a “three-dimensional Hall sensor”. For example, a permanent magnet is arranged on the sensor element 11, and an individual Hall sensor at each operating point 9a. The interrogation of the four individual Hall sensors supplies the information about the route covered by the operating element 11 within the slotted guide 9, and, as a result, indirectly about the operating point 9a situated next. In order to detect the multifunctional operation, i.e. the pivoting and rotational movements, of the operating element 11, use can either be made of the same sensor, or conventional interrogation means, for example sliding contacts, are provided. From the information provided by the sensors and other interrogation means, it is determined in a controller or the like that is known per se which adjuster is to be activated and to what extent.

While a specific embodiment of the invention has been shown and described in detail to illustrate the application of the principles of the invention, it will be understood that the invention may be embodied otherwise without departing from such principles.

1. An operating unit for at least one adjuster of a vehicle seat, the operating unit comprising:
a housing defining a slotted guide;
an operating element mounted for movement such that movement and/or operation of said operating element activates the at least one adjuster, the adjuster adjusting the vehicle seat or a component of the vehicle seat, said operating element being moveable along an operating element path defined by said slotted guide, said operating element path having a contour corresponding to a profile of the vehicle seat.

2. An operating unit as claimed in claim 1, wherein said slotted guide has individual discrete operating points, one of said operating points receiving said operating element such that said operating element activates the at least one adjuster when said operating element is located at said one of said operating points, said slotted guide having connecting sections, one connecting section connecting one of said operating points with another of said operating points, said operating element not activating the at least one adjuster when said operating element is located in one of said connecting sections.

3. An operating unit as claimed in claim 2, wherein each operating point corresponds to one or more adjusters of the vehicle seat or each operating point corresponds to a different operating function for adjusting said one or more adjusters of the vehicle seat.

4. An operating unit as claimed in claim 3, wherein a position of one of the operating points within the slotted guide corresponds to an assigned adjuster, said assigned adjuster moving one or more of a backrest component of the vehicle seat, a bottom portion of the vehicle seat and another portion of the vehicle seat when said operating point is located within said one of the operating points.

5. An operating unit as claimed in claim 2, wherein said operating element receives a force such that said operating element moves in an oblique direction or pivots or rotates about an axis thereof when said operating element is located at said one of said operating points.

6. An operating unit as claimed in claim 5, wherein said operating element performs, at least some operating functions assigned to the operating points.

7. An operating unit as claimed in claim 2, wherein said operating element is moveable from one operating point to another operating point via one of said connecting sections.

8. An operating unit as claimed in claim 2, wherein said operating element is not assigned to a new adjuster when said operating element is located in one of the connecting sections.

9. An operating unit as claimed in claim 2, wherein said operating element is located in a bearing in the housing when said operating element is located at said one of said operating points, said operating element being latched into said bearing when said operating element is located at said one of said operating points.

10. An operating unit as claimed in claim 9, wherein said operating element is lifted or pressed out of the bearing along a longitudinal axis of said operating element when said operating element moves from said one of said operating points to said one of said connecting sections.

11. A operating unit as claimed in claim 1, further comprising a sensor detecting a position of the operating element within the slotted guide.

12. An operating unit as claimed in claim 11, wherein said sensor registers operations of the operating element.

13. An operating unit as claimed in claim 11, wherein said sensor is a three-dimensional Hall sensor.

14. A vehicle seat, comprising:
a plurality of vehicle seat components;
a plurality of adjusters, one adjuster being connected to one of said vehicle seat components;
an operating unit comprising:
a housing defining an operating element guide path with a first operating element receiving position and a second operating element receiving position;
an operating element mounted for movement such said operating element moves from said first operating element receiving position to said second operating receiving position along said operating element guide path, said operating element being movable when said operating element is in said first operating element receiving position and said second operating element receiving position such that movement of said operating element activates one or more said adjusters, one of said adjusters moving one of said vehicle seat components from a first position to a second position when said operating element activates said one or more said adjusters, said operating element guide path having a shape corresponding to a shape of one of said vehicle seat components.

15. A vehicle seat as claimed in claim 14, wherein said vehicle seat components comprises a leg engaging seat portion, said operating unit being located on one side of said leg engaging seat portion.

16. A vehicle seat as claimed in claim 14, wherein said plurality of adjusters includes a first group of adjusters and a second group of adjusters, said first operating element receiving position corresponding to said first group of adjusters, said second operating element corresponding to said second group of adjusters, said first group of adjusters being different than said second group of adjusters, said operating element actuating at least one of said adjusters in said first group of adjusters when said operating element is in said first operating element receiving position, said operating element actuating at least one of said adjusters in said second group of adjusters when said operating element is in said second operating element receiving position.

17. A vehicle seat as claimed in claim 16, wherein said operating element is movable in one or more of a forward direction, a rearward direction, a vertical direction and a rotational direction when said operating element is in one of said first operating element receiving and said second operating element receiving position.

18. A vehicle seat as claimed in claim 17, wherein one of said adjusters is moved in said forward or rearward direction when said operating element is moved in said forward direction or said rearward direction, another of said adjusters moving in said vertical direction when said operating element is moved in said vertical direction, yet another of said adjusters pivoting from a first position to a second position when said operating element is moved in a rotational direction.

19. A vehicle seat, comprising:
a plurality of vehicle seat components;
a first group of first adjusters, one first adjuster being connected to one of said vehicle seat components;
a second group of second adjusters, one second adjuster being connected to one of said vehicle seat components;
an operating unit comprising:
a housing defining an operating element guide path with a first operating element receiving position and a second operating element receiving position, said first operating element receiving position corresponding to said first group of first adjusters, said second operating element receiving position corresponding to said second group of second adjusters;
an operating element mounted for movement such said operating element moves from said first operating element receiving position to said second operating receiving position, said operating element being movable in said first operating element receiving position such that said operating element actuates at least one of said first adjusters, said operating element being movable in said second operating element receiving position such that said operating element actuates at least one of said second adjusters, said operating element guide path having a shape corresponding to a shape of one of said vehicle seat components.

20. A vehicle seat as claimed in claim 19, wherein movement of said operating element corresponds to movement of at least one of said first adjusters when said operating element is in said first operating element receiving position, and movement of said operating element corresponds to movement of at least one of said second adjusters when said operating element is in said second operating element receiving position.
